(19) United States
(12) Patent Application Publication
(10) Pub. No.: US 2021/0404084 A1
(43) Pub. Date: Dec. 30, 2021

(54) ELECTROLYTIC OXIDATION OF COMPOSITE MATERIALS

(71) Applicant: HEWLETT-PACKARD DEVELOPMENT COMPANY, L.P., SPRING, TX (US)

(72) Inventors: YONG-JUN LI, SHANGHAI (CN); KUAN-TING WU, TAIPEI CITY (TW); XIAO-JUN ZHU, CHONGQING (CN)

(21) Appl. No.: 16/341,249

(22) PCT Filed: Feb. 7, 2017
(86) PCT No.: PCT/US2017/016773

§ 371 Date: Apr. 11, 2019

(51) Int. Cl. C25D 11/02; B32B 15/08; B32B 15/14; B32B 5/02; B32B 15/09; B32B 15/088; B32B 15/082; B32B 15/18; B32B 15/20; B32B 27/28; B32B 27/30; B32B 27/34; B32B 27/36; C25D 11/04; C25D 11/26; C25D 11/30; C25D 11/34

(52) U.S. Cl. CPC C25D 11/024; B32B 2307/73; B32B 15/14; B32B 5/02; B32B 15/09; B32B 15/088; B32B 15/082; B32B 15/18; B32B 15/20; B32B 27/285; B32B 27/286; B32B 27/288; B32B 27/302; B32B 27/308; B32B 27/34; B32B 27/36; B32B 27/365; C25D 11/04; C25D 11/26; C25D 11/30; C25D 11/34; B32B 2250/02; B32B 2255/06; B32B 2255/20; B32B 2262/106; B32B 2307/7145; B32B 15/08

(57) ABSTRACT

The present subject matter relates to techniques of electrolytic oxidation for composite materials. In an example, a method includes immersing a composite material into an electrolytic solution for electrolytic oxidation, wherein the composite material comprises a metal alloy substrate and a second substrate. The method further includes providing a predetermined voltage to the electrolytic solution after every predefined time interval, wherein the voltage triggers electrolytic oxidation of the metal alloy substrate.

### BACKGROUND

A composite material is a material generally made from one or more substrate materials and is generally used for manufacturing of various components of devices, such as housings for laptops, mobile phones, and other electronic devices. Further, components of the devices, such as a stylus and keyboard are also made of composite materials. The composite material is made such that the composite material is durable and can withstand wear and tear due to regular use, and is also light weight so as to form the various components of the devices such that they are easily portable.

### BRIEF DESCRIPTION OF DRAWINGS

The following detailed description references the drawings, wherein:

FIG. 1 illustrates a process of electrolytic oxidation of a composite material, according to an example implementation of the present subject matter:

FIG. 2 illustrates a voltage-time relation during an electrolytic oxidation of a composite material, according to an example implementation of the present subject matter;

FIG. 3 illustrates a voltage-time relation during an electrolytic oxidation of a composite material, according to an example implementation of the present subject matter:

FIG. 4 illustrates a voltage-time relation during an electrolytic oxidation of a composite material, according to an example implementation of the present subject matter;

FIG. 5 illustrates a composite material after electrolytic oxidation, according to an example implementation of the present subject matter; and

FIG. 6 illustrates a method of electrolytic oxidation of a composite material, according to an example implementation of the present subject matter.

### DETAILED DESCRIPTION

Generally, durable and light weight composite materials are made from a combination of metal and/or non-metal substrates. For example, a metal alloy substrate is combined with plastic to form a composite material. Composite materials used for manufacturing of components, for example, housings for devices, are generally made from metal alloy substrates combined with other substrates, such as a plastic or carbon fiber substrates.

To enhance the durability of the composite material, the composite material is also subjected to a process of electrolytic oxidation. The electrolytic oxidation allows formation of a metal oxide layer over the metal alloy substrate, providing a continuous barrier to the metal alloy substrate and making the composite material resistant to wear and tear, corrosion, and heat abrasions. However, during electrolytic oxidation, high voltage is applied which causes burning of joints between the metal alloy substrates and the other substrates.

According to an aspect of the present subject matter, techniques of electrolytic oxidation are described. The described techniques provide a controlled electrolytic oxidation of a composite material and allow formation of an oxide layer over metal alloy substrate, while causing no damage to joints between the metal alloys substrates and other substrates.

In an example implementation of the present subject matter, a composite material of a metal alloy substrate and another substrate is immersed in an electrolytic solution for electrolytic oxidation. For the ease of explanation, the other substrate utilized in the composite material is referred as a second substrate, hereinafter. It would be noted that the second substrate may be made of plastic, carbon fiber, or carbon fiber composites, and may be combined with the metal alloy substrate.

For deposition of the oxide layer over the metal alloy substrate, a predetermined voltage is applied to the electrolytic solution. In an example implementation of the present subject matter, the predetermined voltage is applied after every predefined time interval. The supply of the predetermined voltage after every predefined time interval may control the temperature of the electrolytic solution, such that the oxide layer is deposited over the metal alloy substrate, without causing any burn to the joints of the metal alloy substrate and the second substrate.

In an example, the predetermined voltage may be supplied after every 3 to 5 seconds, for a period of about 5 to 30 seconds. For instance, a predetermined voltage of 200 Volts (V) may be applied for a period of 20 seconds, and after an interval of every 4 seconds. In an example implementation of the present subject matter, the predefined time interval may change depending upon physical properties of the metal alloy substrate, and the second substrate. It would be noted that interrupting the voltage for the predefined time period, such as for 4 seconds, controls the increase in temperature of the electrolytic solution and allows controlled electrolytic oxidation of composite materials, without damaging substrates during the process.

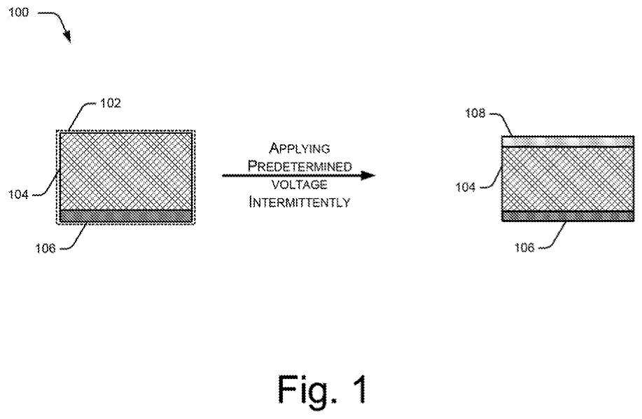

The above techniques are further described with reference to FIGS. 1-4. It would be noted that the description and the figures merely illustrate the principles of the present subject matter along with examples described herein, and would not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 illustrates a process 100 of electrolytic oxidation of a composite material 102, according to an example implementation of the present subject matter. The composite material 102 may include a metal alloy substrate 104 combined to a second substrate 106.

The metal alloy substrate 104 may be any light weight metal alloy which is durable and can be coupled with other light weight second substrates, such as the second substrate 106. In an example, the metal alloy substrate 104 is made of any one of magnesium, aluminum, lithium, zinc, niobium, steel, copper, titanium, and a combination thereof.

Further, the second substrate 106 may be any durable light weight substrate which can be integrated with the metal alloy substrate 104. In an example, the second substrate 106 may be made of any one of plastic, carbon fiber, and carbon fiber composite. In an example implementation, any of plastics, such as polybutylene terephthalate (PBT), polyphenylenesulfide (PPS), polyamide (nylon), polyphthalamide (PPA), polymethylmethacrylate (PMMA), polyetheretherketone (PEEK), acrylonitrile butadiene styrene (ABS), polycarbonate (PC), ABS/PC, and polypropylene with 15-50% glass fiber may be used as the second substrate 106. In another example implementation, any one of carbon fibers, such as polyacrylonitrile (PAN), rayon, pitch and aramid carbon fibers may be used as the second substrate 106.

The metal alloy substrate 104 and the second substrate 106 may be combined to each other to form the composite material 102 using different techniques, such as adhesive bonding, fastening, riveting, and insert molding. Further, different processes of insert molding may be used to obtain the composite material 102. In an example, the techniques used to couple the metal alloy substrate 104 and the second substrate 106 may be based on the selection of the metal alloy substrate 104 and the second substrate 106. For example, a magnesium alloy substrate may be insert molded with a plastic substrate to form the composite material 102.

In an example implementation of the present subject matter, the composite material 102, prior to being subjected to the process 100 of electrolytic oxidation, may be processed through polishing, degreasing, activating, and/or neutralizing, the surfaces of the metal alloy substrate 104. The surfaces of the metal alloy substrate 104 in the composite material 102 may be polished using polishing agents, such as abrasives to remove surface irregularities, such as burrs on the surfaces of the metal alloy substrate 104. In an example implementation, the surfaces of the metal alloy substrate 104 may be polished through one of electro-polishing, mechanical polishing, and buffing.

After polishing, the surfaces of the metal alloy substrate 104 may be degreased to remove impurities, such as fat, grease, and oil from the surfaces of the metal alloy substrate 104. In an example implementation, the surfaces of the metal alloy substrate 104 may be degreased through ultrasonic degreasing by using alkaline cleaners. The surfaces of the metal alloy substrate 104 may also be degreased by passing hot water over the insert-molded component.

After degreasing, the surfaces of metal alloy substrate 104 may be activated to remove any layer of natural oxides that may have formed on the metal alloy substrate 104 due to exposure to the atmosphere. In an example implementation, the surfaces of metal alloy substrate 104 may be activated through acid activation. Acids, such as nitric acid, acetic acid, and sulfuric acid may be used for acid activation. Acid activation also removes alkaline solutions that may have adhered to the surfaces of the metal alloy substrate 104 while the metal alloy substrate 104 is degreased using alkaline cleaners.

After activation, the surfaces of the metal alloy substrate 104 may be neutralized. In an example implementation, the surfaces of the metal alloy substrate 104 may be neutralized through alkaline neutralization using weak alkaline solutions, such as alkaline solutions of one of sodium carbonate, sodium hydroxide, ammonia, and sodium hexametaphosphate. After the composite material 102 is processed, the composite material 102 is oxidized through the process 100 of electrolytic oxidation to form an oxide layer 108 on the metal alloy substrate 104.

During the process 100 of electrolytic oxidation, the composite material 102 is immersed in an electrolytic solution. In an example implementation, electrolytic oxidation includes electrolysis of an electrolytic solution with the composite material 102 immersed in the electrolytic solution. The electrolytic solution may be an alkaline solution of one of sodium silicate, metal phosphate, potassium fluoride, potassium hydroxide or sodium hydroxide, fluorozirconate, sodium hexametaphosphate, sodium fluoride, ferric ammonium oxalate, phosphoric acid salt, graphite powder, silicon dioxide powder, aluminum oxide powder, metal powder, and polyethylene oxide alkylphenolic ether. In an example implementation, the electrolytic solution has a concentration in a range of about 0.05% by volume to about 15% by volume and has a pH in a range of about 8 to about 13.

In an example implementation, the electrolytic solution may be kept inside an electrolytic bath and maintained at a temperature in a range of about 10-degrees Celsius (C) to about 45-degrees C. The composite material 102 is immersed in the electrolytic solution inside the electrolytic bath. The composite material 102 acts as an electrode during electrolysis of the electrolytic solution.

For electrolytic oxidation, a predetermined voltage is applied to the electrolytic solution after every predefined time interval. In other words, the electrolytic oxidation may be controlled, such that the predetermined voltage is applied to the electrolytic solution, after every predefined time interval in a non-continuous manner. The supply of the predetermined voltage after every predefined time interval may control the temperature of the electrolytic solution, such that the oxide layer 108 is deposited over the metal alloy substrate 104, without causing any burn to joints of the metal alloy substrate 104 and the second substrate 106.

The predetermined voltage may vary between 150 Volts and 500 Volts, depending upon the metal alloy substrate 104 and the second substrate 106. Further, the predetermined voltage may be applied for a time period of about 5 seconds to 30 seconds, depending upon the metal alloy substrate 104 and the second substrate 106. It would be noted that combination of the metal alloy substrate 104 and the second substrate 106 may vary where different metal alloy substrate 104 and different second substrate 106 may be utilized to prepare the composite material 102. Therefore, the predetermined voltage, and the time period of its application may accordingly be varied to deposit the oxide layer 108 over the metal alloy substrate 104 of the composite material 102.

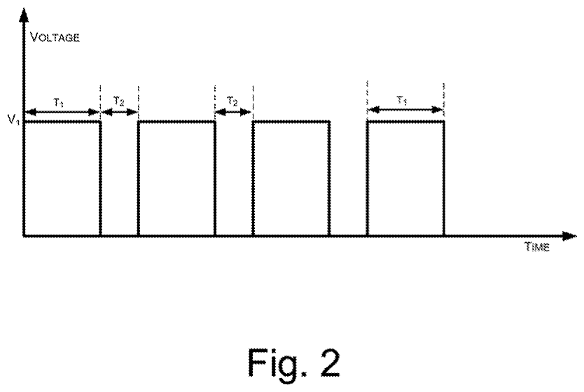

For the ease of understanding, the manner in which the predetermined voltage is applied to the electrolytic solution has been further described in reference of FIG. 2.

FIG. 2 illustrates a voltage-time relation during the electrolytic oxidation of the composite material 102, in accordance with an example of the present subject matter. As an example, the relation between the voltage applied to the electrolytic solution and time duration for which the voltage is applied, has been depicted by way of a graph. In the graph, the vertical axis (Y-axis) represents the voltage applied to the electrolytic solution and the horizontal axis (X-axis) represents the time of the electrolytic oxidation.

In an example implementation of the present subject matter, a predetermined voltage of V₁ volts is applied to the electrolytic solution for a time period of T₁ seconds. Thereafter, the supply of the voltage to the electrolytic solution is stopped for the predefined time interval of T₂ seconds. Further, the predetermined voltage is again applied to the electrolytic solution for a period of T₁ seconds. The process of applying the predetermined voltage V₁ to the electrolytic solution intermittently may be repeated until the oxide layer 108 is deposited onto the metal alloy substrate 104 of the composite material 102. Therefore, it would be noted that the predetermined voltage is supplied to the electrolytic solution after every predefined time interval, to deposit the oxide layer 108 on the metal alloy substrate 104. In an example, a voltage of 200 volts may be applied to the electrolytic solution for a duration of 20 seconds. Thereafter, the supply of voltage may be stopped for a duration of 4 seconds. Further, the voltage of 200 volts may again be applied for a period of 20 seconds. This process of applying the voltage to the electrolytic solution may be repeated until the oxide layer 108 is formed on the metal alloy substrate 104 of the composite material 102.

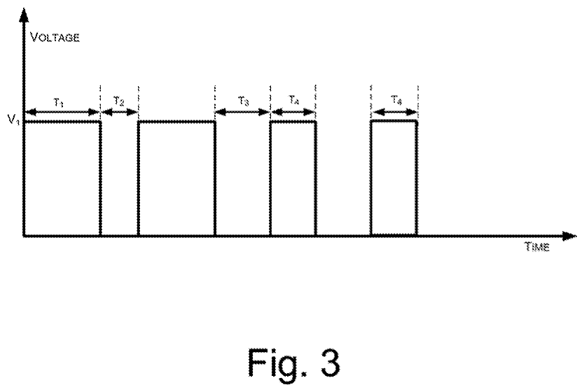

In an example implementation of the present subject matter, the time period for which the predetermined voltage is applied, and the time period for which the voltage is not applied, may be varied. FIG. 3 illustrates a voltage-time relation during the electrolytic oxidation of the composite material 102, where the time period for which the predetermined voltage is applied, and the predefined time interval is varied. For example, a predetermined voltage of V₁ volts, say 180 volts, may be first applied to the electrolytic solution for a period of T₁ seconds, say 30 seconds. Thereafter, a gap of predefined time interval of about T₂ seconds, say 3 seconds, may be provided and the predetermined voltage of 180 volts may again be applied. Thereafter, the predefined time interval may be varied and a gap of T₃ seconds, say 5 seconds may be provided. Further, the predetermined voltage of 180 volts may then be applied to the electrolytic solution, for a period of T₄ seconds, say 20 seconds. Furthermore, after applying the predetermined voltage for 20 seconds, the gap of 5 seconds may be provided to the electrolytic oxidation. Therefore, it would be noted that any of the time period for which the voltage is applied, or for which the voltage is not applied, may also be varied. It should be noted that the above example values for T₁ through T₄ are for example and illustration, and that other time values may be used instead.

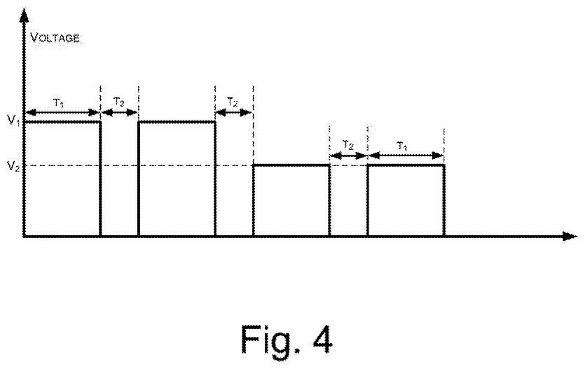

In another example of the present subject matter, the predetermined voltage applied to the electrolytic solution may also be varied during the electrolytic oxidation of the composite material 102. FIG. 4 illustrates a voltage-time relation during the electrolytic oxidation of the composite material 102, where the predetermined voltage applied to the electrolytic solution is varied. For example, a predetermined voltage of V1, say 180 volts, may be applied to the electrolytic solution for a period of 30 seconds. Thereafter, after a gap of 5 seconds, the voltage may again be applied for 30 seconds. Then, the predetermined voltage may be varied and a voltage of 240 volts may be applied to the electrolytic solution. Therefore, during the electrolytic oxidation of the composite material 102, the predetermined voltage may be varied, according to example implementations of the present subject matter.

Therefore, it would be noted that the predetermined voltage, the time period for which the predetermined voltage is applied, and the predefined time interval may all be varied during the electrolytic oxidation of the composite material 102.

In an example implementation of the present subject matter, the variation in the time period, or the variation in the voltage applied to the electrolytic solution may be based on the temperature of the electrolytic solution. That is, to maintain a suitable temperature for the electrolytic oxidation of the composite material 102, the time period, or the voltage applied to the electrolytic solution may be varied.

The thickness of the oxide layer 108 depends on the definite time period for which the electrolytic oxidation is performed. In an example implementation, the oxide layer 108 has a thickness in a range of about 1 micro meter (μm) to about 15 μm. The oxide layer 108 may be formed of a metal oxide, or a combination of metal oxides. For example, when the metal alloy substrate 104 is made of aluminum, then the oxide layer 108 is formed of aluminum oxide (Al₂O₃). In another example, when the metal alloy substrate 104 is made of an alloy of magnesium, aluminum, and zinc, then the oxide layer 108 is formed of a combination of magnesium oxide, aluminum oxide, and zinc oxide.

In an example implementation of the present subject matter, upon electrolytic oxidation of the composite material 102, the composite material 102 may also be subjected to processes of sealing holes and paintings, to further enhance the durability of the composite material 102, along with improving the appearance of the composite material 102. For example, the composite material 102, after the electrolytic oxidation, may be heated at a temperature in a range of 60° C. to 80° C. for a time duration in a range of 10 minutes to 30 minutes, to dry the oxide layer 108.

Further, after drying the oxide layer 108, several coats may be deposited on the composite material 102 to enhance the heat resistive capacity, surface texture, and/or aesthetic appeal. For example, the composite material 102 may be painted with a coating layer, and wherein the coating layer is one of hydrophobic, anti-bacterial, anti-smudge, and anti-fingerprint layer.

Therefore, based on the described process 100 of electrolytic oxidation, the composite material 102 may be coated with the oxide layer 108 while causing no damage to the substrates or to the joints between the substrates of the composite material 102.

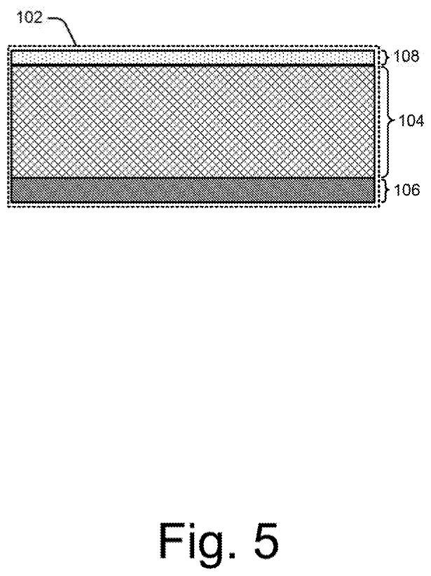

FIG. 5 illustrates a composite material after electrolytic oxidation, according to an example implementation of the present subject matter. The composite material 102 may include the metal alloy substrate 104 and the second substrate 106. Further, the composite material 102 may also include the oxide layer 108, formed through a process of electrolytic oxidation, where a predetermined voltage is supplied to the electrolytic solution for electrolytic oxidation after every predefined time interval. The metal alloy substrate 104 and the second substrate 106 of the composite material 102 may be coupled to each other through any known means, such as insert molding.

In an example implementation of the present subject matter, the oxide layer 108 is formed through a controlled electrolytic oxidation where the supplied predetermined voltage may vary between 150 volts to about 500 volts. Further, the time period for which the voltage is applied may vary between 5 seconds to about 30 seconds. In an example, the predefined time interval may vary between 3 seconds to about 5 seconds, and the thickness of the formed oxide layer 108 may vary between 1 μm to about 15 μm.

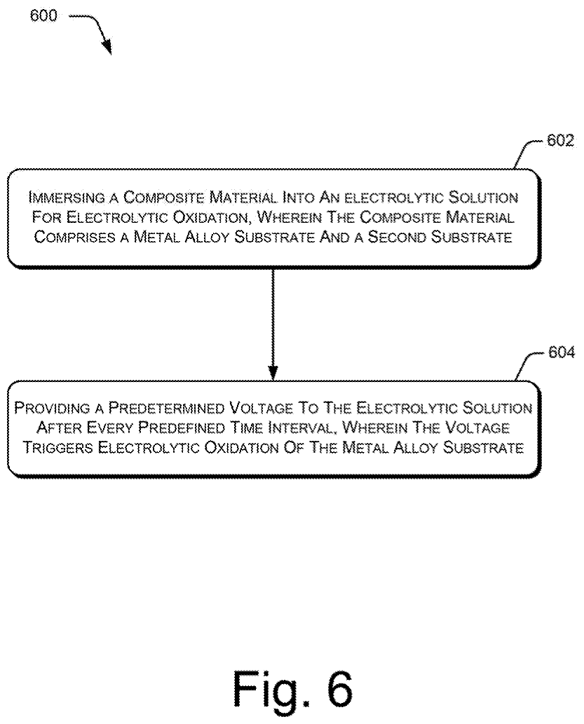

FIG. 6 illustrates a method 600 for electrolytic oxidation of composite material, according to an example implementation of the present subject matter.

In an example implementation, the composite material may be fabricated by combining a metal alloy substrate along with a second substrate. The electrolyzed composite material may be utilized for various purposes, such as a top cover of a laptop computer, a back cover or a top cover of a tablet, and a back cover or a top cover of a smartphone.

At block 602, the composite material is immersed into an electrolytic solution for electrolytic oxidation, wherein the composite material comprises a metal alloy substrate and a second substrate. In an example implementation of the present subject matter, the metal alloy substrate is coupled with the second substrate, such as plastic, carbon fiber, and carbon fiber composites through known techniques of coupling, such as adhesive bonding, fastening, riveting, and insert molding.

In an example, the electrolytic solution may be an alkaline solution of one of sodium silicate, metal phosphate, potassium fluoride, potassium hydroxide or sodium hydroxide, fluorozirconate, sodium hexametaphosphate, sodium fluoride, ferric ammonium oxalate, phosphoric acid salt, graphite powder, silicon dioxide powder, aluminum oxide powder, metal powder, and polyethylene oxide alkylphenolic ether. Further, the electrolytic solution may have a concentration in a range of about 0.05% by volume to about 15% by volume and a pH in a range of about 8 to about 13.

In an example implementation, the electrolytic solution may be kept inside an electrolytic bath and maintained at a temperature in a range of about 10-degrees C. to about 45-degrees C. The composite material may act as an electrode during the electrolytic oxidation.

At block 604, a predetermined voltage is provided to the electrolytic solution, after every predefined time interval. The supply of the voltage to the electrolytic solution may trigger the electrolytic oxidation of the metal alloy substrate to form an oxide layer over the surface of the metal alloy substrate. In an example, the predetermined voltage may vary between 150 volts to about 500 volts, and may be supplied for about 5 seconds to 30 seconds. The predefined time interval for which the voltage may not be supplied may range between 3 to 5 seconds.

The electrolytic oxidation of the composite material may allow formation of the oxide layer on the surface of the metal alloy substrate. In an example, the oxide layer of about 10 μm may be deposited over the composite material. The described techniques of electrolytic oxidation may allow controlled and safe oxidation of the metal alloy substrate, and may control the increase in temperature of the electrolytic solution.

In an example implementation of the present subject matter, upon electrolytic oxidation of the composite material, the composite material may also be subjected to processes of sealing holes, coating with different layers, and paintings, to further enhance the durability of the composite material. For example, the composite material may be painted with a coating layer, and wherein the coating layer is one of hydrophobic, anti-bacterial, anti-smudge, and anti-fingerprint layer to enhance the heat resistive capacity, surface texture, and/or aesthetic appeal.

Although examples for the present disclosure have been described in language specific to structural features and/or methods, it would be understood that the appended claims are not necessarily limited to the specific features or methods described. Rather, the specific features and methods are disclosed and explained as examples of the present disclosure.

We claim:

1. A method of electrolytic oxidation for a composite material, the method comprising:
immersing the composite material into an electrolytic solution for electrolytic oxidation, wherein the composite material comprises a metal alloy substrate and a second substrate; and
providing a predetermined voltage to the electrolytic solution after every predefined time interval, wherein the predetermined voltage triggers electrolytic oxidation of the metal alloy substrate.

2. The method as claimed in claim 1, wherein the metal alloy substrate is made of one of magnesium, aluminum, lithium, zinc, niobium, steel, copper, titanium, and a combination thereof.

3. The method as claimed in claim 1, wherein the second substrate is made of one of plastic, carbon fiber, and carbon fiber composite.

4. The method as claimed in claim 1, wherein the method further comprises varying the predetermined voltage based on temperature of the electrolytic solution.

5. The method as claimed in claim 1, wherein the providing comprises supplying the predetermined voltage after the predefined time interval of about 3 seconds to 5 seconds.

6. The method as claimed in claim 1, wherein the providing comprises supplying the predetermined voltage for about 5 seconds to 30 seconds after every predefined time interval.

7. The method as claimed in claim 1, wherein the providing comprises supplying the predetermined voltage of about 150 Volts to 500 Volts.

8. A composite material comprising:
a metal alloy substrate;
a second substrate coupled with the metal alloy substrate, wherein the metal alloy substrate is covered with an oxide layer formed by a controlled electrolytic oxidation, and wherein the controlled electrolytic oxidation is carried out by providing a predetermined voltage after every predefined time interval during the electrolytic oxidation process.

9. The composite material as claimed in claim 8, wherein the metal alloy substrate is made of one of magnesium, aluminum, lithium, zinc, niobium, steel, copper, titanium, and a combination thereof, and wherein the second substrate is made of one of plastic, carbon fiber, carbon fiber composites, and a combination thereof.

10. The composite material as claimed in claim 9, wherein the composite material is painted with a coating layer, and wherein the coating layer is one of hydrophobic, anti-bacterial, anti-smudge, and anti-fingerprint layer.

11. The composite material as claimed in claim 8, wherein the second substrate is one of polybutylene terephthalate (PBT), polyphenylene sulfide (PPS), Polyamide (nylon), polythalamide (PPA), polymethyl methacrylate (PMMA), polyetheretherketone (PEEK), acrylonitrile butadiene styrene (ABS), polycarbonate (PC), and combinations thereof.

12. The composite material as claimed in claim 8, wherein the second substrate is a carbon fiber made of one of polyacrylonitrile (PAN), rayon, pitch, aramid, and combinations thereof.

13. The composite material as claimed in claim 8, wherein the second substrate is insert-molded to the metal alloy substrate.

14. The composite material as claimed in claim 8, wherein the oxide layer is of about 1 micrometer (μm) to 15 μm in thickness.

15. The composite material as claimed in claim 8, wherein the predefined time interval is varied based on temperature of electrolytic solution in the electrolytic oxidation process.
